(19) United States
(12) Patent Application Publication
(10) Pub. No.: US 2025/0258885 A1
(43) Pub. Date: Aug. 14, 2025

(54) AI-POWERED WEBPAGE BUILDING SYSTEM AND METHOD

(71) Applicant: Law Office of Jerry Joseph, PLC, Washington, DC (US)

(72) Inventors: Vincent Salernitano, Ashburn, VA (US); Tomas Marin, Ashburn, VA (US)

(21) Appl. No.: 19/050,045

(22) Filed: Feb. 10, 2025

Related U.S. Application Data
(60) Provisional application No. 63/551,603, filed on Feb. 9, 2024.

(51) Int. Cl. G06F 16/958; G06F 8/38

(52) U.S. Cl. CPC G06F 16/958; G06F 8/38

(57) ABSTRACT

Exemplary embodiments provide a system for building a webpage. The system may include at least one processor configured to execute processor executable instructions, and a non-transitory computer-readable storage medium including processor executable instructions. When the processor executes the instructions, the processor is operative to receive data corresponding to a webpage having a webpage design and a webpage structure, analyze the webpage design and structure, generate computer code or webpage output language corresponding to the webpage design and structure, and store the computer code in the non-transitory computer-readable storage medium.

### BACKGROUND OF THE INVENTION

### 1. Field of the Invention

The present general inventive concept relates to methods and systems for building webpages. More particularly, the present general inventive concept relates to generating computer code corresponding to the design and structure of a webpage.

### 2. Description of Related Art

There have been previous systems and methods that have been developed for creating webpages and websites. For purposes herein, the terms webpage and website are used interchangeably. With these prior systems and methods, manual entry of every single line of code corresponding to the webpage design and structure is required. However, such systems and methods are time consuming and have a significant risk error.

Therefore, what is desired is a system and method for building websites and webpages that utilizes artificial intelligence to understand the design and structure of a webpage and then generate computer code corresponding to the webpage design and structure. This improvement is significant because there currently exists a disconnect between designing a webpage and coding it. That is, a webpage design and structure may be challenging to replicate in code, especially through conventional, manual means. The present general inventive concept eliminates this disconnect.

### SUMMARY OF THE INVENTION

Exemplary embodiments provide a system for building a webpage. The system may include at least one processor configured to execute processor executable instructions, and a non-transitory computer-readable storage medium including processor executable instructions. When the processor executes the instructions, the processor is operative to receive data corresponding to a webpage having a webpage design and a webpage structure, analyze the webpage design and structure, generate computer code or webpage output language corresponding to the webpage design and structure, and store the computer code in the non-transitory computer-readable storage medium.

In alternative exemplary embodiments, the system may be configured to use artificial intelligence software to analyze the webpage design and structure.

In alternative exemplary embodiments, the system may be configured to use artificial intelligence software to generate the computer code corresponding to the webpage design and structure.

In alternative exemplary embodiments, the artificial intelligence software may include at least one of ChatGPT, Google Gemini AI Models, and OpenAI GPT.

In alternative exemplary embodiments, the processor may be configured to communicate the stored computer code.

In alternative exemplary embodiments, the processor may be configured to communicate with at least one internet design platform, and the processor may be configured to receive the webpage design and structure from the internet design platform.

In alternative exemplary embodiments, the internet design platform may comprise Figma.

In alternative exemplary embodiments, the system may be configured to convert the webpage design and structure into at least one of a plurality of webpage output languages. That is, the computer code may be generated in any type of webpage output language or computer code language or any combination of code languages.

In alternative exemplary embodiments, the system may further include a user interface that enables a user to make changes to the webpage design and structure.

In alternative exemplary embodiments, the user interface enables a user to make changes to the webpage design and structure after generation of the computer code corresponding to the webpage design and structure.

In alternative exemplary embodiments, when the processor executes the instructions, the processor may be further operative to automatically update the generated computer code with computer code corresponding to the user changes to the webpage design and structure.

Alternative exemplary embodiments provide a method of building a webpage. The method may include receiving, by a processor, data corresponding to a webpage, wherein the webpage includes a design and structure. The method may further include analyzing, using the processor, the webpage design and structure. The method may further include generating, using the processor, computer code corresponding to the webpage design and structure. The method may further include storing the computer code in a non-transitory computer-readable storage medium.

In alternative exemplary embodiments, the method may further include using artificial intelligence software to analyze the webpage design and structure.

In alternative exemplary embodiments, the method may further include using artificial intelligence software to generate the computer code corresponding to the webpage design and structure.

In alternative exemplary embodiments, the artificial intelligence software may be at least one of ChatGPT, Google Gemini AI Models, and OpenAI GPT.

In alternative exemplary embodiments, the processor is configured to communicate the stored computer code.

In alternative exemplary embodiments, the method may further include communicating, using the processor, with at least one internet design platform, and receiving the webpage design and structure from the internet design platform.

In alternative exemplary embodiments, the internet design platform comprises Figma.

In alternative exemplary embodiments, the computer code corresponding to the webpage design and structure is in at least one of a plurality of webpage output languages.

In alternative exemplary embodiments, the method may further include, after generating of the computer code, automatically updating the generated computer code with computer code corresponding to user changes to the webpage design and structure.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a network diagram of a system for building webpages including a webpage building module according to an exemplary embodiment of the present inventive concept;

FIG. 2 is a flowchart of a method of using a system for building webpages according to an exemplary embodiment of the present inventive concept;

FIG. 3 is a flowchart of a method of using a system for building webpages according to another exemplary embodiment of the present inventive concept; and

FIG. 4 is a flowchart of a method of using a system for building webpages according to another exemplary embodiment of the present inventive concept.

### DETAILED DESCRIPTION OF THE INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

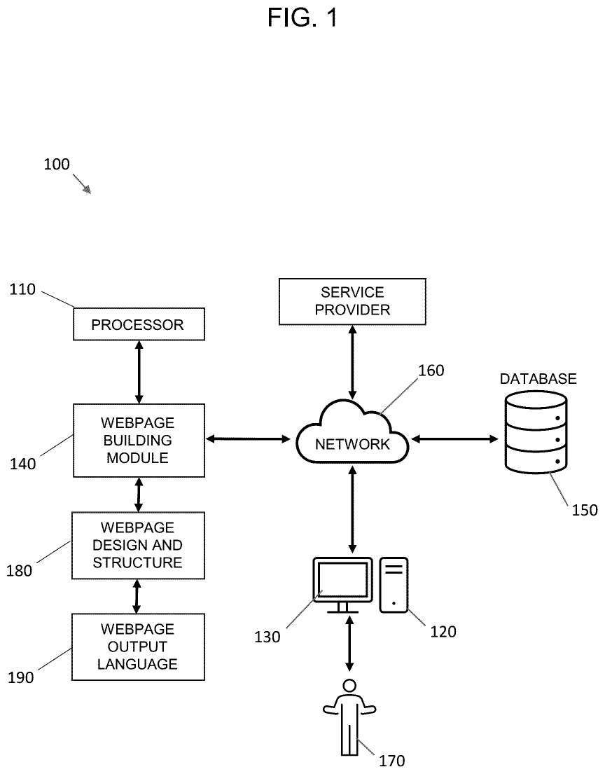

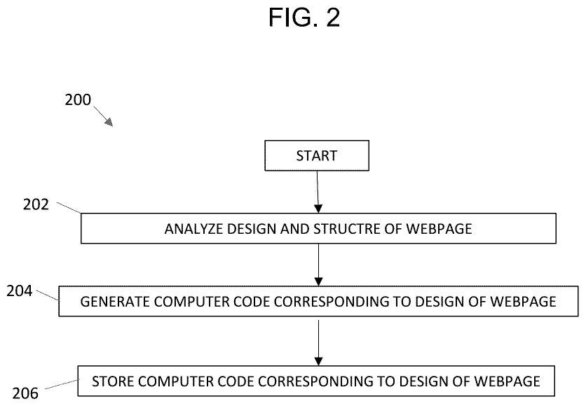

FIG. 1 is a network diagram of a system 100 for building webpages including a webpage building module 140 according to an exemplary embodiment of the present inventive concept and FIG. 2 is a flowchart of a method 200 of using a system for building webpages according to an exemplary embodiment of the present inventive concept.

Referring to FIGS. 1-2, the exemplary system for building webpages, designated generally as 100, is illustrated. In the present embodiment, the system for building a webpage 100 is designed and configured to utilize artificial intelligence to analyze and understand the structure and design of a webpage and to generate computer code or webpage output language corresponding to the webpage design and structure. That is, the exemplary system and method for building a webpage 100 is designed to utilize artificial intelligence to convert a webpage's design and structure descriptions into website code, effectively and accurately. This improvement is significant because it eliminates the potential for error between designing a webpage and coding it, i.e., a webpage's design and structure may be challenging to replicate in computer code using conventional, manual means. As such, users are enabled to automate the computer or software code writing process and to view how a webpage design translates into a live, functioning webpage. However, the present general inventive concept is not limited thereto.

The exemplary system and method for building a webpage 100 is useful for both experienced web developers and beginner web developers. For experienced web developers, it speeds up the workflow by automating the tedious webpage development step where the webpage design and structure is converted into computer code or webpage output language. During manual or human conversion, this step has a high risk of error.

The computer code corresponding to the design and structure of the webpage comprises the building blocks of any webpage. That is, the design and structure of a webpage are translated into computer code through a combination of different types of computer code language or webpage output language for the different elements of the webpage design and structure. For example, different languages are used for the visual structure of the webpage, the styling, and for interactivity. However, additional languages may be used for other features or elements of the webpage. The process of translating the webpage design and structure into computer code or webpage output language is tedious and the process involves careful planning, coding, and testing to create a function and user-friendly webpage and/or website.

For beginner web developers, the present inventive concept enables them to understand how their web designs are translated into real, functioning websites, without needing extensive coding knowledge. Further, it represents a significant step in integrating artificial intelligence into the webpage design and development process, making it easier and more efficient to turn creative ideas into live webpages. Still further, the present general inventive concept generates a highly accurate computer code corresponding to the webpage design and structure. However, the present general inventive concept is not limited thereto.

The integration of artificial intelligence into the tedious process of translating a webpage design and structure into computer code or webpage output language provides significant benefits and efficiencies. That is, the present generally inventive concept is configured to utilize artificial intelligence to significantly streamline the process of translating a webpage design and structure into computer code. The exemplary system according to the present general inventive concept is configured to analyze design and structure files and automatically generate computer code or webpage output language corresponding to the design and structure of the webpage.

The exemplary system 100 is configured to interpret the layout of the design, including grids, spacing, and positioning of elements. The system 100 is configured to extract color palettes, typography, and other visual styles from the design and translate them into webpages output language. The system 100 is configured to identify reusable components like buttons and navigation bars and to generate webpages output language for them. The system 100 is configured to assist developers in writing code by suggesting relevant snippets and completing lines based on the context and desired functionality. The system 100 is configured to speed up the coding process by automating repetitive tasks and providing intelligent suggestions as well as helping users and developers write more efficient, maintainable, and error free code. The system 100 is further configured to provide real-time feedback, suggest improvements, and event automatically fix minor errors.

The exemplary system 100 is further configured to provide to users via displays of associated remote electronic devices a dynamic user interface to build a webpage and have it translated into webpage output language or computer code, and to provide a system for making updates and design and structure changes to the webpage after generation of the computer code corresponding to the webpage, and to have those updates and design and structure changes incorporated into the generated computer code or webpage output language by the system, thereby automatically updating the previously generated computer code or webpage output language of the webpage. The exemplary user interface provides a quick and easy solution to effectuate these webpage design and structure changes. The user interface may include a webpage design platform, access to artificial intelligence, and is associated with a processor that is configured to communicate with various other components of the system, as well as external systems, servers, devices, or other processors or computers.

In exemplary embodiments, as shown in FIG. 1, the exemplary system 100 comprises at least one processor 110, at least one input device 120, at least one display screen 130, a webpage design platform module 140, and a non-transitory processor readable storage medium 150.

The exemplary system 100 is configured to utilize artificial intelligence software to analyze and understand the design and structure data of a webpage. In one embodiment, system 100 utilizes artificial intelligence software or code stored in a local processor readable storage medium 150 to analyze a webpage's design and structure and to translate the webpage design and structure into computer code or webpage output language using a webpage building module 140. In other embodiments, system 100 is configured to access, connect with, or communicate with artificial intelligence software or code stored remotely or accessible via the Internet, such as ChatGPT®, Google Gemini® Artificial Intelligence (AI) Models, or OpenAI® GPT. However, other artificial intelligence services may be used as well. In such embodiments, system 100 uses the accessible artificial intelligence software or code to analyze and understand the webpage's design and structure and to convert the design and structure into computer code. However, the present general inventive concept is not limited thereto.

In exemplary embodiments, the processor 110 may comprise, but is not limited to, one or more processors of computers, smart devices, smart phones, or any other electronic devices. The exemplary processor 110 may include one or more general-purpose processors responsible for executing the core logic and instructions involved in the conversion process, such as analyzing design files, generating code, and optimizing performance. The exemplary processor 110 may comprise graphics processing units to provide highly parallel processors that excel at handling the intensive computations often involved in image and visual data processing, such as analyzing and translating visual elements from the design into CSS styles. The exemplary processor 110 may include field programmable gate arrays to provide customizable hardware devices that can be reconfigured to perform specific tasks efficiently. FPGAs can accelerate certain aspects of the conversion process, such as image recognition or low-level code generation. The exemplary processor 110 may include specialized AI/ML processors designed specifically for accelerating machine learning tasks, such as those used in AI-powered code generation tools that learn from existing codebases and design patterns to generate optimized code.

The exemplary input device 120 comprises, but is not limited to, at least one of a computer mouse, a track pad, a touch screen, a voice command software or system or any other input device.

The exemplary display screen 130 comprises, but is not limited to, a computer screen, a smart phone display screen, a smart device display screen, a projector, or any other type of display or display screen.

The exemplary webpage design platform module 140 comprises, but is not limited to, any webpage design platform module, system, or software accessible through the internet, Internet-of-Things or via any network. The webpage design platform module 140 is coupled with a processor 110 and may be accessible by a user 170 through a user interface 120, 130 associated with the system 100.

The exemplary processor readable storage medium 150 comprises, but is not limited to, any storage medium, memory device, memory system, data store, server, cloud-based server, or other storage system and is configured to store data, computer code, and information used by or generated by the system 100.

In exemplary embodiments, the processor 110, input device 120, and display screen 130 are in wired or wireless connection. The exemplary storage medium 150 is configured to store data and/or computer code generated or used by the system 100 to facilitate functions, operations, and method steps described herein. The exemplary system 100 is configured to communicate with other devices or systems through at least one telecommunications, data, or wireless communications network 160. The exemplary webpage design platform 140 may comprise computer code stored on the medium 150 or the platform 140 may be embodied in another storage medium accessible by the system 100 through the network 160. However, the present general inventive concept is not limited thereto.

In exemplary embodiments, the system 100 is configured to generate from the webpage design and structure 180 computer code or webpage output language 190 from the webpage design and structure 180. In exemplary arrangements, the system 100 is configured to generate webpage output language 190 in the form of HyperText Markup Language (HTML) for the structure and content of the webpage. The system 100 is configured to generate webpage output language 190 in the form of Cascading Style Sheets (CSS) to control the visual presentation of the HTML elements and to determine the color, fonts, layout, and spacing. The system 100 is configured to generate webpage output language 190 in the form of JavaScript to enable interactivity between various webpages and to enable dynamic behavior such as responding to user actions (for example, clicking and hovering over portions of the webpage), manipulating page content, creating animations and effects, and communicating with other services or electronic devices. In alternative exemplary embodiments, the system 100 is configured to output webpage output language 190 in the form of Server-Side Language (for example, PHP, Python, Node.js) to process data on the web server, interact with databases, handle user input, and generate dynamic content, as well as build web applications, create user accounts, and manage e-commerce transactions. However, the exemplary, webpage output, languages are not limited hereto, and the exemplary system may use or generate a plurality of different types of webpage output languages to properly code the webpage design and structure. However, the present general inventive concept is not limited hereto.

As shown in FIG. 2, an exemplary method 200 of using the system 100 is provided. In exemplary method 200, a user 170 has already created a webpage design and structure 180 which the user 170 intends to have converted into computer code or webpage output code 190. However, in alternative embodiments, the exemplary method 1000 includes the steps of a user 170 creating a webpage design and structure 180.

At step 202, system 100 receives and/or analyzes the webpage design and structure 180 and stores data corresponding to the design and structure 180 in the storage medium 150.

At step 204, system 100 generates, using artificial intelligence, computer code 190 corresponding to the webpage design and structure 180.

At step 206, system 100 stores the computer code or webpage output language 190 in the medium 150.

In alternative embodiments, system 100 is configured to access artificial intelligence software to generate the computer code or webpage output language 190. However, in still other embodiments, system 100 utilizes its own processor readable code to convert the webpage design and structure into computer code without the need for an artificial intelligence application.

In alternative embodiments, system 100 is configured to access the webpage design platform known as Figma to enable users to create and build a webpage through the system 100. However, system 100 is configured to work in conjunction with any webpage design platform, system, or software.

In alternative embodiments, system 100 is configured to convert the webpage design into any type of computer code or webpage output code or language, for example, HTML, CSS, Javascript, or Server-Side Language. However, the present general inventive concept is not limited thereto.

In alternative embodiments, the exemplary system 100 is configured to communicate with Amazon Web Services® (AWS) and Google Cloud Platform® (CGP) for cloud computing services and storage. In this way, the exemplary system 100 is equipped with a plurality of virtual servers, having various resources for use on demand, including CPU, RAM, and storage. Exemplary system 100 is further equipped with serverless computing in order to run code without managing servers, and system 100 is configured to deploy and manage containerized applications. Further, the exemplary system 100, in communicating with AWS and GCP, is enabled to store and retrieve large amounts of data, provide high-performance storage for applications needing low latency access, and store and analyze massive data sets for business intelligence. However, the present general inventive concept is not limited hereto.

In alternative embodiments, the system 100 includes a user interface for the user 170 to interact with the system 100. The user interface may be displayed to the user 170 through a web-based system platform module 140 which may include a series of webpages. However, the present general inventive concept is not limited hereto.

In alternative exemplary embodiments where the webpage design platform 140 comprises Figma®, the system 100 may include the webpage design platform 140 as a plugin to the system 100. In such embodiments, the system 100 enables data extraction. In addition, the system 100 enables a web-based user interface builder component that allows users to manage and modify the user 170 processed designs after conversion from the webpage building module 140, for example, Figma® to webpage output language 190. This provides the user 170 with the ability to preview, edit, and customize the generated computer code or webpage output language 190 through an interactive web-based interface. The user 170 is provided with the ability to make post-processing adjustments to their designs without needing to return to webpage design platform 140 or another webpage design platform 140, or to modify code directly. That is, the user is enabled to make changes to the design and structure 180 of the webpage after the computer code or webpage output language or code 190 has been generated, and the system 100 is configured to change the generated output language or code 190 to include the post-generation user changes to the design and structure 180, in real time or close to real time. However, the present general inventive concept is not limited hereto.

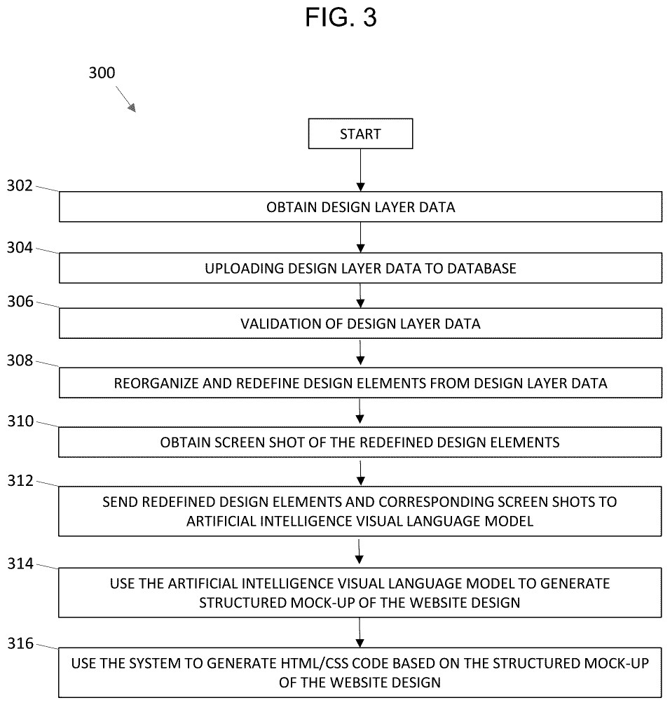

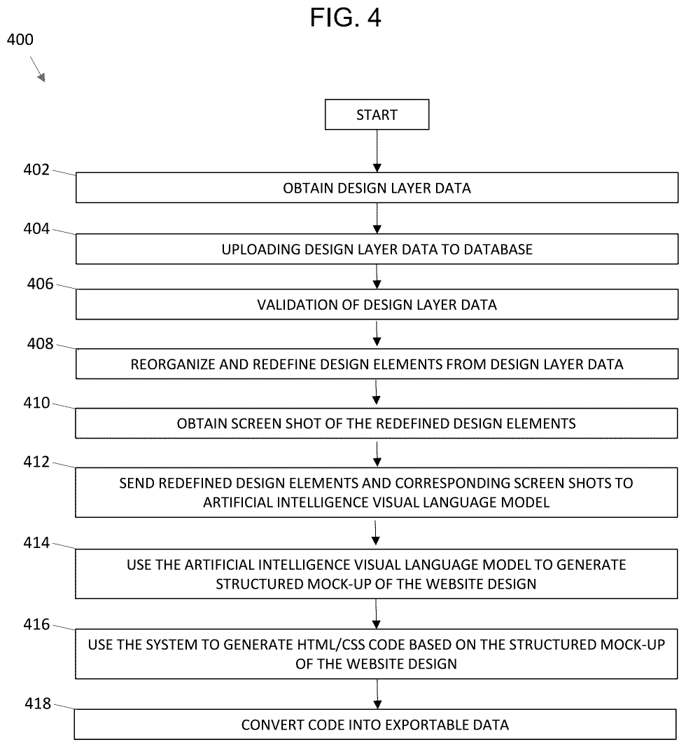

FIG. 3 is a flowchart of a method 300 of using a system 100 for building webpages according to another exemplary embodiment of the present inventive concept and FIG. 4 is a flowchart of a method 400 of using a system 100 for building webpages according to another exemplary embodiment of the present inventive concept.

As shown in FIG. 3, an exemplary method 300 of using the system 100 is provided. In exemplary method 300, at step 302, the system 100 obtains a design layer data of a website.

At step 304, system 100 uploads the design layer data of the website to a database 150.

At step 306, system 100 validates the design layer data.

At step 308, system 100 reorganizes and redefines design elements from the validated design layer data.

At step 310, system 100 obtains a screenshot of each of the redefined design elements.

At step 312, system 100 sends the redefined design elements and the corresponding screenshots to an artificial intelligence visual language model.

At step 314, system 100 uses the artificial intelligence visual language model to generate structured mock-up of the website design.

Lastly, at step 316, system 100 generates html/css code based on the structured mock-up of the website design

As shown in FIG. 4, an exemplary method 400 of using the system 100 is provided. The present embodiment of the method 400 is similar to the previous embodiment, but further includes using the system 100 to convert the generated html/css code into exportable data.

In exemplary method 400, at step 402, the system 100 obtains a design layer data of a website.

At step 404, system 100 uploads the design layer data of the website to a database 150.

At step 406, system 100 validates the design layer data.

At step 408, system 100 reorganizes and redefines design elements from the validated design layer data.

At step 410, system 100 obtains a screenshot of each of the redefined design elements.

At step 412, system 100 sends the redefined design elements and the corresponding screenshots to an artificial intelligence visual language model.

At step 414, system 100 uses the artificial intelligence visual language model to generate structured mock-up of the website design.

At step 416, system 100 generates html/css code based on the structured mock-up of the website design.

Lastly, at step 418, system 100 converts the generated html/css code into exportable data.

Although a few exemplary embodiments of the present general inventive concept have been illustrated and described, it will be appreciated by those skilled in the art that changes may be made in these exemplary embodiments, and combinations of the features and relationships of the various embodiments may made to form new embodiments, without departing from the principles and spirit of the general inventive concept, the scope of which is defined in the appended claims and their equivalents.

1. A system for building a webpage, comprising:
at least one processor configured to execute processor executable instructions, and a non-transitory computer-readable storage medium including processor executable instructions, wherein when the processor executes the instructions, the processor is operative to:
receive data corresponding to a webpage, wherein the webpage has a design and a structure, analyze the webpage design and structure, generate computer code corresponding to the webpage design and structure, and
store the computer code in the non-transitory computer-readable storage medium.

2. The system according to claim 1, wherein the system is configured to use artificial intelligence software to analyze the webpage design and structure.

3. The system according to claim 2, wherein the system is configured to use artificial intelligence software to generate the computer code corresponding to the webpage design and structure.

4. The system according to claim 3, wherein the artificial intelligence software includes at least one of ChatGPT, Google Gemini AI Models; and OpenAI GPT.

5. The system according to claim 4, wherein the processor is configured to communicate the stored computer code.

6. The system according to claim 5, wherein the processor is configured to communicate with at least one webpage design platform, and wherein the processor is configured to receive the webpage design and structure from the webpage design platform.

7. The system according to claim 6, wherein the webpage design platform comprises Figma.

8. The system according to claim 7, wherein the system is configured to convert the webpage design and structure into at least at least one of a plurality of webpage output languages.

9. The system according to claim 8, further comprising:
a user interface, wherein the user interface enables a user to make changes to the webpage design and structure.

10. The system according to claim 9, wherein the user interface enables a user to make changes to the webpage design and structure after generation of the computer code corresponding to the webpage design and structure.

11. The system according to claim 10, wherein when the processor executes the instructions, the processor is further operative to:
automatically update the generated computer code with computer code corresponding to the user changes to the webpage design and structure.

12. A method of building a webpage, comprising:
receiving, by a processor, data corresponding to a webpage, wherein the webpage includes a design and structure;
analyzing, using the processor, the webpage design and structure;
generating, using the processor, computer code corresponding to the webpage design and structure; and
storing the computer code in a non-transitory computer-readable storage medium.

13. The method according to claim 12, further comprising:
using artificial intelligence software to analyze the webpage design and structure.

14. The method according to claim 13, further comprising:
using artificial intelligence software to generate the computer code corresponding to the webpage design and structure.

15. The method according to claim 14, wherein the artificial intelligence software includes at least one of ChatGPT; Google Gemini AI Models; and OpenAI GPT.

16. The method according to claim 15, wherein the processor is configured to communicate the stored computer code.

17. The method according to claim 16, further comprising:
communicating, using the processor, with at least one webpage design platform, and receiving the webpage design and structure from the webpage design platform.

18. The method according to claim 17, wherein the webpage design platform comprises Figma.

19. The method according to claim 18, wherein the computer code corresponding to webpage design and structure is in at least one of a plurality of webpage output languages.

20. The method according to claim 19, further comprising:
after generation of the computer code, automatically updating the generated computer code with computer code corresponding to user changes to the webpage design and structure.
